(19) United States
(12) Patent Application Publication
(10) Pub. No.: US 2025/0376137 A1
(43) Pub. Date: Dec. 11, 2025

(54) VALVE ASSEMBLY FOR A PNEUMATIC SYSTEM OF A VEHICLE, IN PARTICULAR A COMMERCIAL VEHICLE, PNEUMATIC SYSTEM, VEHICLE, IN PARTICULAR COMMERCIAL VEHICLE, METHOD AND COMPUTER PROGRAM AND/OR COMPUTER-READABLE MEDIUM

(71) Applicant: ZF CV Systems Global GmbH, Bern (CH)

(72) Inventor: Julian van Thiel, Grossburgwedel (DE)

(21) Appl. No.: 19/307,711

(22) Filed: Aug. 22, 2025

Related U.S. Application Data
(63) Continuation of application No. PCT/EP2024/053722, filed on Feb. 14, 2024.

(30) Foreign Application Priority Data
Feb. 28, 2023 (DE) 10 2023 104 841.4

(51) Int. Cl. B60T 8/50; B60T 8/34; B60T 8/46; B60T 17/06

(52) U.S. Cl. CPC B60T 8/5087; B60T 8/343; B60T 8/46; B60T 17/06; B60T 2270/10; B60T 2270/88

(57) ABSTRACT

A valve assembly for a pneumatic system of a vehicle, in particular a commercial vehicle, including: an outlet valve assembly for venting the pneumatic system, a control device for operating the valve assembly in order to admit and release air to and from a pneumatic actuator, wherein the control device is configured to output, to the outlet valve assembly, a switching signal for switching the outlet valve assembly, and, via the switching signal, the outlet valve assembly can be switched to a noise-reducing first venting mode or a quick-venting second venting mode.

### CROSS-REFERENCE TO RELATED APPLICATIONS

This application is a continuation application of international patent application PCT/EP2024/053722, filed Feb. 14, 2024, designating the United States and claiming priority from German application 10 2023 104 841.4, filed Feb. 28, 2023, and the entire content of both applications is incorporated herein by reference.

### TECHNICAL FIELD

The present disclosure relates to a valve assembly for a pneumatic system of a vehicle, in particular a commercial vehicle. The disclosure also relates to a pneumatic system for a vehicle, in particular a commercial vehicle, to a vehicle, in particular a commercial vehicle, to a method for operating a valve assembly for a pneumatic system of a vehicle, in particular a commercial vehicle, and a computer program and/or computer-readable medium.

### BACKGROUND

With the increasing electrification of drive systems, reducing noise emissions is becoming more important on modern vehicles, especially for vehicles that can be driven in part and/or exclusively by electric means.

One source of noise may be a pneumatic system. Such systems include a compressed air reservoir and/or a compressor, which can supply an inlet valve with an air pressure. The inlet valve is connected to a working volume of a pneumatic actuator which, when actuated and/or after being actuated, releases an air flow through an outlet valve. Particularly during release or venting through the outlet valve, noise may occur. It is possible to restrict release. However, restricting release may have an effect on the actuation of the actuator. For a service brake system as a pneumatic system, for example, restriction should not be performed in certain situations; instead, the outlet valve should be actuated for as rapid as possible venting.

DE 10 2020 214 971 A1 discloses a brake system for a motor vehicle having a hydraulic line system with at least one normally closed hydraulic valve, wherein an output stage for electric control of the at least one hydraulic valve is provided. To minimize noise emissions, the output stage is an output stage suitable for analogue control, and a computing unit is provided which is configured to determine a valve flow on the basis of a pressure difference across the hydraulic valve and to operate the output stage so as to make available the valve flow at the hydraulic valve.

DE 10 2014 009 179 A1 discloses a valve assembly for brake control in a pressure-medium-operated brake system of a vehicle, including at least one relay valve arranged in a housing, and at least one solenoid valve for controlling the relay valve. To enable the production and installation of the valve assembly to be simplified, the required installation space to be kept very small and the number of components to be reduced, the housing has at least one cylindrical receptacle for a relay valve piston, the receptacle being closed at one end and forming a control chamber, a working chamber and a pressure chamber, and has an insert and a carrier element for a plate valve, which can be inserted axially in this order into the receptacle and fixed therein. In this case, the carrier element can have a receiving space for a muffler.

DE 10 2019 131 110 A1 furthermore discloses a method for the reliable emergency stopping of a commercial vehicle having an electronically controllable pneumatic brake system with spring brake cylinders on at least one axle, wherein the electronically controllable pneumatic brake system includes a service brake system and at least one first redundant system, wherein, in the case of a first fault in the service brake system, the vehicle is braked via the redundant system, wherein the electronically controllable brake system furthermore has an unrestricted venting path and a venting path that is restricted in comparison with the latter, for venting the spring brake cylinders. The method is distinguished by the following steps: determining a second fault in the redundant system and, in response thereto: automatically restricted venting of at least one of the spring brake cylinders via the restricted venting path for slow, safe stopping of the vehicle.

### SUMMARY

It is an object of the disclosure to reduce noise emissions associated with pneumatic venting and, at the same time, if necessary, bringing about quick venting.

The object is achieved by various embodiments of the disclosure

According to an aspect of the disclosure, a valve assembly for a pneumatic system of a vehicle, in particular a commercial vehicle, is provided. The valve assembly includes: an outlet valve assembly for venting the pneumatic system, a control device for operating the valve assembly in order to admit and release air to and from a pneumatic actuator, wherein the control device is configured to output, to the outlet valve assembly, a switching signal for switching the outlet valve assembly, and, via the switching signal, the outlet valve assembly can be switched to a noise-reducing first venting mode or a quick-venting second venting mode.

The disclosure is based on the fact that muffling measures in the outlet valve assembly or in a venting portion are in general often associated with a reduction or limitation of venting gradients. Venting is thus restricted. However, since high gradients for venting, that is, quick venting, are not always absolutely essential, it is envisaged that the venting mode can be switched over via the switching signal in order to enable the outlet valve assembly to be operated with noise reduction in the first venting mode or with quick venting in the second venting mode.

Via the disclosure, it is possible to operate an electropneumatic vehicle system or appliance which is configured to switch between noise-reducing venting and quick or gradient-optimized venting. Here, activation of the corresponding mode is effected by the switching signal output by the control device, which can reflect a respective vehicle situation and/or urgency or criticality of the respective venting in order to bring about venting by the outlet valve assembly in accordance therewith.

As an option, the control device is configured to output the switching signal taking into account a vehicle state, the vehicle speed and/or a driving situation. In this case, the vehicle speed can be interpreted as a vehicle state and/or as characterizing a vehicle state. In particular, the driving situation can characterize whether a situation is critical to stability and/or relevant to safety as regards the driving dynamics. For example, a stability-critical and safety-relevant driving situation can be emergency braking. In this case, the outlet valve assembly can be switched to the second venting mode at a high speed of the vehicle in a stability-critical and/or safety-relevant driving situation in order to make possible corresponding dynamics and performance of the actuator, for example, in the event of engagement of a brake. However, the frequency of such engagements is low, and a corresponding engagement tends to take place at relatively high speeds, at which noise emissions are likely to be tolerable in corresponding emergency situations. At a low speed, the outlet valve assembly can switch to the first venting mode in order to reduce noise emissions. Venting that is optimized for noise can be employed particularly when stationary and/or at low vehicle speeds since, in this case, the venting noises are not covered to the same extent by other vehicle and/or driving noises and may therefore be perceived as more troublesome.

As an option, the first venting mode is optimized for noise and/or the second venting mode is optimized for venting. Via the first venting mode, the outlet valve assembly can achieve venting with minimum noise emissions. Via the second venting mode, the outlet valve assembly can achieve unrestricted and as rapid as possible venting.

As an option, the outlet valve assembly can be switched via the switching signal to a hybrid venting mode, wherein, in the hybrid venting mode, the outlet valve assembly can be switched to the first venting mode and to the second venting mode. In this case, it is possible, in addition or as an alternative to the first venting mode and the second venting mode, for the outlet valve assembly to be switched in intermediate stages and/or with a time offset to the first venting mode, the second venting mode and/or an intermediate stage. For example, the hybrid venting mode can be a compromise or balance between a venting mode optimized for noise and a venting mode with maximum venting speed, that is, optimized for the gradient. In this case, as many intermediate stages as desired can be selected in the hybrid venting mode.

As an option, the outlet valve assembly is configured, via the switching signal, to be switched to the first venting mode above a pressure threshold defining the threshold value condition and/or to the second venting mode below the pressure threshold. It is therefore possible to start venting with noise reduction at a high pressure to avoid initial and severe noise emissions (acoustic shock effect). When the initial noise emissions have been avoided, it is possible to switch to the quick-venting venting mode. In other words, this embodiment allows initially slow and increasingly quick opening of the outlet valve via the switching signal, depending on a threshold value condition relating to a pressure.

As an option, the outlet valve assembly is configured to enable air emerging from the outlet valve assembly to be fed to a vehicle component different from the valve assembly. It is thereby possible to significantly reduce the emissions of pneumatic venting noises and, at the same time, to reuse the energy stored in the pneumatic compressed air in some other process in the vehicle before or during venting in order to improve the energy efficiency of the overall vehicle. For example, the vehicle component can be a central air preparation system of the vehicle, a fuel cell system and/or a compressor of a fuel cell system. In this case, it is possible, during venting in the venting mode optimized for noise, for the compressed air to be fed to some other vehicle process in order to enable more energy-efficient operation of the respective process step.

As an option, the outlet valve assembly includes a noise-reducing valve and a quick-venting valve. The outlet valve assembly can thus have two valves, each adapted and/or optimized for one venting mode. The noise-reducing valve can release air with particularly little noise and can be selected in the first venting mode. The quick-venting valve can release air particularly quickly and can be selected in the second venting mode. The noise-reducing valve and/or the quick-venting valve can be switched to the hybrid venting mode and can thus be switched simultaneously and/or successively.

As an option, the valve assembly has a housing, and the noise-reducing valve and the quick-venting valve are arranged in the housing. The outlet valve for quick venting and noise-reducing venting can thus be integrated in a common housing. Effective guidance of the air during venting and integrated arrangement of the components of the valve assembly are thus possible.

As an option, the outlet valve assembly includes a switchover device and a switchable outlet valve, wherein the switchover device is configured, via the switching signal, to switch the outlet valve to the first venting mode or the second venting mode. Via the switchover device, the outlet valve and thus the outlet valve assembly can be switched between the venting modes. In this case, the outlet valve can be switched by varying the air flowing through the outlet valve. For example, the outlet valve itself is capable of being switched to several outlet modes and/or a restriction device is connected upstream and/or downstream of the outlet valve.

As an option, the valve assembly is configured to switch the outlet valve assembly to the quick-venting second venting mode in a de-energized state. In the event of a defect which leads to failure of the supply of electric current to the valve assembly, it is thereby possible to provide a fallback level which allows quick venting.

According to an aspect of the disclosure, a pneumatic system for a vehicle, in particular a commercial vehicle, including the valve assembly described above is provided. In this case, the valve assembly can have one or more features described as optional in order to achieve a technical effect associated therewith.

As an option, the pneumatic system includes an electropneumatic service brake system, an electropneumatic parking brake system, an electropneumatic air suspension system and/or an electropneumatic transmission. It is advantageous for the valve assembly to be used, in particular, in the electropneumatic service brake system and/or electropneumatic parking brake system. Use in an electropneumatic air suspension system, an electropneumatic transmission automation system or other electropneumatic systems in the vehicle is also possible.

As an option, the pneumatic system includes an electropneumatic service brake system, and the outlet valve assembly includes one or more ABS valves. The anti-lock system valves (ABS valves) are valves of the service brake system. For safety reasons, it may be necessary to operate the ABS valves in the second venting mode in a safety-relevant situation, although such a safety-relevant situation seldom occurs and the outlet valve assembly can have a noise-reducing valve for situations that are not safety-relevant. Alternatively, the ABS valves can be switchable between the first venting mode and the second venting mode.

As an option, the pneumatic system includes a muffling device, and the ABS valve or valves is/are configured to vent via the muffling device in the first venting mode. A further reduction in noise emissions is thereby possible.

According to an aspect of the disclosure, a vehicle, in particular a commercial vehicle, including the pneumatic system described above is provided. In this case, the valve assembly of the pneumatic system can have one or more features described as optional in order to achieve a technical effect associated therewith.

According to an aspect of the disclosure, a method for operating a valve assembly for a pneumatic system of a vehicle, in particular a commercial vehicle, is provided. In this case, the method includes: outputting a switching signal to an outlet valve assembly of the valve assembly; and switching the outlet valve assembly to the outlet valve assembly to a noise-reducing first venting mode or a quick-venting second venting mode via the switching signal. In this case, the method can be carried out in such a way that one or more features as described with reference to the valve assembly and/or to the pneumatic system are implemented in order to achieve a technical effect associated therewith.

According to an aspect of the disclosure, a computer program and/or a computer-readable medium is/are provided. The computer program and/or the computer-readable medium includes/include commands which, when the program or the commands is/are executed by a computer, cause the latter to carry out the method according to the disclosure and/or steps of the method. As an option, the computer program and/or the computer-readable medium includes/include commands which, when the program or the commands are executed by a computer, cause the latter to carry out the method steps described as advantageous or optional in order to achieve a technical effect associated therewith.

### BRIEF DESCRIPTION OF DRAWINGS

The invention will now be described with reference to the drawings wherein:

FIG. 1 shows a schematic illustration of a pneumatic system according to an embodiment of the disclosure;

FIG. 2 shows a schematic illustration of a pneumatic system according to an embodiment of the disclosure;

FIG. 3 shows a schematic illustration of a vehicle, in particular a commercial vehicle, according to an embodiment of the disclosure; and,

FIG. 4 shows a schematic illustration of a flow diagram of a method according to an embodiment of the disclosure.

### DETAILED DESCRIPTION

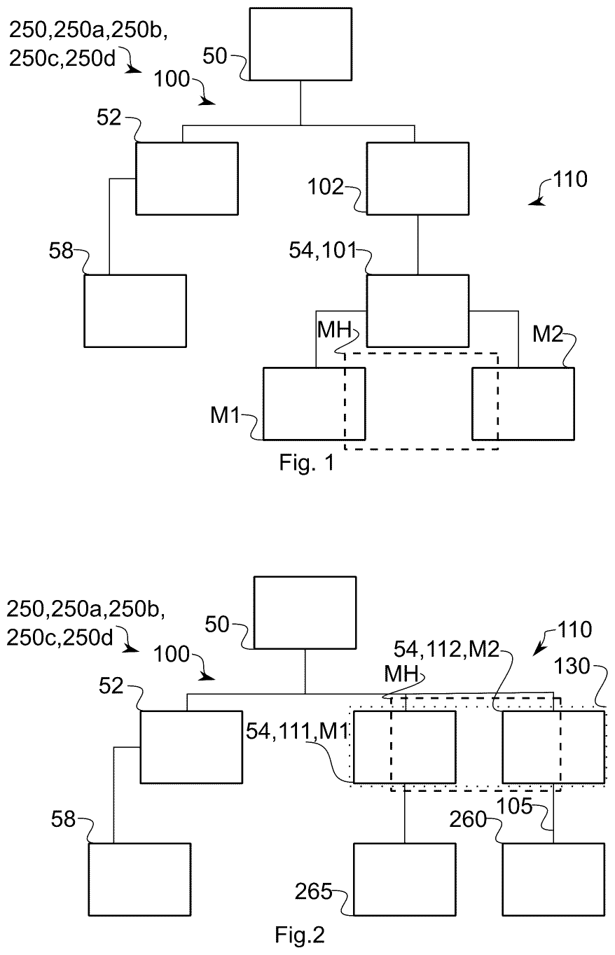

FIG. 1 shows a schematic illustration of a pneumatic system 250 according to an embodiment of the disclosure.

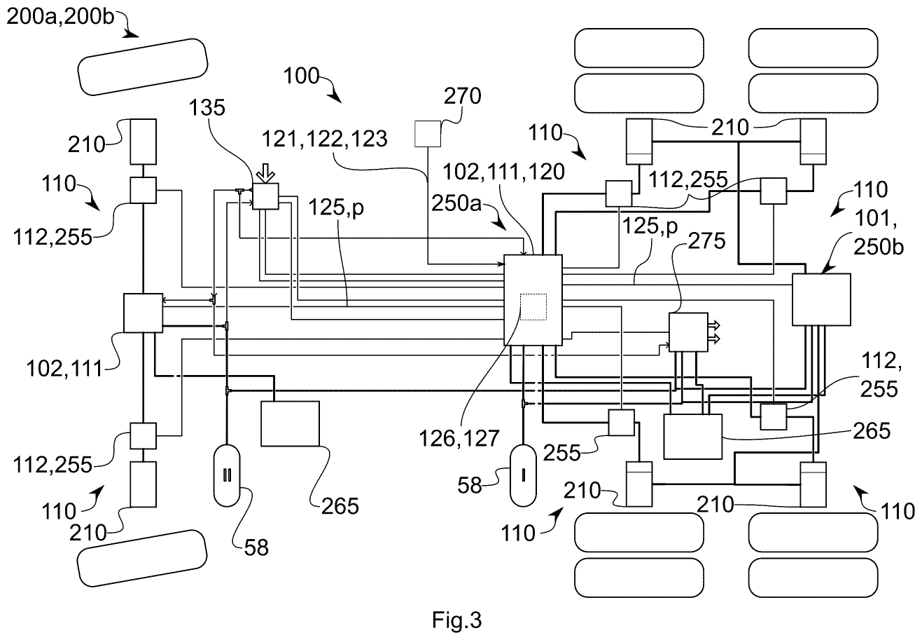

The pneumatic system 250 is configured to be used in a vehicle 200a, in particular a commercial vehicle 200b. For this purpose, the pneumatic system 250 includes an electropneumatic service brake system 250a (see FIG. 3), an electropneumatic parking brake system 250b (see FIG. 3), an electropneumatic air suspension system 250c and/or an electropneumatic transmission 250d.

The vehicle 200a, in particular a commercial vehicle 200b, is referred to below as vehicle 200a, 200b. A vehicle 200a, 200b of this kind is shown in FIG. 3 and is described with reference to FIG. 3.

The pneumatic system 250 according to FIG. 1 includes a valve assembly 100, a compressed air reservoir 58 and a working volume 50 of an actuator 210 (see FIG. 3). The valve assembly 100 includes an inlet valve 52, which connects the compressed air reservoir 58 and the working volume 50 fluidically. The inlet valve 52 is configured to supply the working volume 50 of the actuator 210 with air from the compressed air reservoir 58 and thus to admit air to it.

The valve assembly 100 includes an outlet valve assembly 110. The outlet valve assembly 110 is configured to vent the working volume 50 of the actuator 210 and thus the pneumatic system 250, that is, to release air. Thus, the valve assembly 100 is configured to admit and release air to and from the working volume 50 of the actuator 210.

The valve assembly 100 includes a control device 120 (see FIG. 3) for operating the valve assembly 110. In this case, the outlet valve assembly 110 is configured to receive a switching signal 125 (see FIG. 3) from the control device 120 and to be operated in accordance with the switching signal 125. For this purpose, the outlet valve assembly 100 includes a switchover device 102 and an outlet valve 54. The outlet valve 54 is a switchable outlet valve 101. The switchover device 102 is configured, via the switching signal 125, to switch the switchable outlet valve 101 to a noise-reducing first venting mode M1 or a quick-venting second venting mode M2. Here, the first venting mode M1 is optimized for noise, and the second venting mode M2 is optimized for venting. In this case, it is possible in the second venting mode M2 for an additional venting cross section to be added upstream and/or downstream of the outlet valve 101 and for venting to be maintained in parallel via a noise-optimized venting portion of the outlet valve 101.

The outlet valve assembly 110 can be switched to a hybrid venting mode MH via the switching signal 125. The hybrid mode MH is illustrated schematically by a box in dashed lines which overlaps the first venting mode M1 and the second venting mode M2. In the hybrid venting mode MH, the outlet valve assembly 110 is switched to the first venting mode M1 and to the second venting mode M2.

The valve assembly 100 is configured to switch the outlet valve assembly 110 to the quick-venting second venting mode M2 in a de-energized state.

FIG. 2 shows a schematic illustration of a pneumatic system 250 according to an embodiment of the disclosure. FIG. 2 shows an embodiment of a pneumatic system 250, in which the outlet valve assembly 110 has alternative features to the embodiment shown in FIG. 1. FIG. 2 is described with reference to FIG. 1, with differences between the embodiments being described.

The outlet valve assembly 110 according to FIG. 2 includes two outlet valves 54, namely a noise-reducing valve 111 and a quick-venting valve 112. The noise-reducing valve 111 can be selected in the first venting mode M1, and the quick-venting valve 112 can be selected in the second venting mode M2. As an option, the pneumatic system includes a switchover device 102 not shown in FIG. 2, as described with reference to FIG. 1, wherein the switchover device 102 is configured to switch the noise-reducing valve 111 and/or the quick-venting valve 112. In the first venting mode M1, the quick-venting valve 112 can be deactivated, and venting can take place solely via the noise-reducing valve 111. In the second venting mode M2, the quick-venting valve 111 can be deactivated, and venting can take place solely via the quick-venting valve 112. Both valves 111, 112 are selectable in the hybrid venting mode MH and can thus be operated simultaneously and/or successively.

The valve assembly 100 has a housing 130, which is indicated only schematically by a dotted line, and the noise-reducing valve 111 and the quick-venting valve 112 are arranged in the housing 130.

The outlet valve assembly 110 is configured to ensure that air 105 emerging from the outlet valve assembly 110 is fed to a vehicle component 260 different from the valve assembly 100. For this purpose, the quick-venting valve 112 is connected fluidically to the vehicle component 260. Air 105 emerging via the quick-venting valve 112 when the working volume 50 is vented can thus be fed as process gas to the vehicle component 260, for example, in order to operate the vehicle component 260, to assist the operation of the vehicle component 260 and/or to increase the efficiency of the vehicle component 260.

The pneumatic system 250 includes a muffling device 265. The outlet valve assembly 110 is configured to ensure that gas emerging from the outlet valve assembly 110 is fed to the muffling device 265. For this purpose, the noise-reducing valve 111 is connected fluidically to the muffling device 265. Gas emerging via the noise-reducing valve 111 when the working volume 50 is vented is fed to the muffling device 265 in order to further reduce noise emissions.

The vehicle component 260 and/or the muffling device 265 can be supplied in similar fashion with gas emerging from the switchable outlet valve 101 according to FIG. 1.

FIG. 3 shows a schematic illustration of a vehicle 200a, in particular a commercial vehicle 200b, according to an embodiment of the disclosure. The vehicle 200a, 200b includes the embodiment of the pneumatic system 250 described with reference to FIG. 1 as a parking brake system 250b and the embodiment of the pneumatic system 250 described with reference to FIG. 2 as a service brake system 250a. FIG. 3 is described with reference to FIGS. 1 and 2.

The vehicle 200a, 200b according to FIG. 3 is a land vehicle, in particular a tractor and/or a trailer of a multi-element vehicle 200a, 200b.

The vehicle 200a, 200b has a braking value transmitter 135. The braking value transmitter 135 can include, for example, a brake pedal with a valve substructure in order to convert a braking request on the part of the driver into a signal for operating the pneumatic system 250 and/or for converting a braking request made by an automated driving function into a signal for operating the pneumatic system 250.

The vehicle 200a, 200b includes the service brake system 250a and the parking brake system 250b. The service brake system 250a includes a valve assembly 100 having a plurality of outlet valve assemblies 110, in particular one outlet valve assembly 110 per wheel brake, and two switchover devices 102. The parking brake system 250b includes an outlet valve assembly 110.

The vehicle 200a, 200b includes a control device 120. The control device 120 (control module) is configured to operate components of the service brake system 250a and of the corresponding outlet valve assemblies 110 which affect the parking brake system 250b and the rear axles of the vehicle 200a, 200b. The control device 120 can therefore also be referred to as a rear axle modulator (RAM). At the same time, the control device 120 is configured as a rear switchover device 102. The control device 120 is connected to the braking value transmitter 135 in order to receive a braking signal corresponding to the braking request.

The front switchover device 102 is configured to operate components of the service brake system 250a and of the corresponding outlet valve assemblies 110 which affect the front axle of the vehicle 200a, 200b. The switchover device 102 can therefore also be referred to as a front axle modulator (FAM). The front switchover device 102 is connected to the braking value transmitter 135 in order to receive a braking signal corresponding to the braking request.

The control device 120 is configured to output, to the outlet valve assemblies 110, a switching signal 125 for switching the outlet valve assemblies 110. For this purpose, the control device 120 is connected for communication purposes to the switchover device 102 of the front axle, the FAM, for example, via a vehicle bus 270.

Via the switching signal 125, the outlet valve assemblies 110 can be switched to a noise-reducing first venting mode M1 or a quick-venting second venting mode M2. The control device 120 is configured to output the switching signal 125 taking into account a vehicle state 121, the vehicle speed 122 and/or a driving situation 123. For this purpose, the control device 120 is connected to the vehicle bus 270 in order to be able to receive and process the vehicle state 121, the vehicle speed 122, the driving situation 123 and/or information relating thereto. Venting the service brake system 250a during a stability intervention, for example, a yaw control operation, is, for example, a venting operation of high criticality and must take place quickly in the second venting mode M2. Such a stability intervention requires highly dynamic and precise control of the brake pressure or of the resulting braking torques. One example of a critical venting operation in the second venting mode M2 in the electropneumatic parking brake system 250b is emergency braking via the parking brake 250b while driving.

The outlet valve assembly 110 can be switched via the switching signal 125 in accordance with a threshold value condition 126 relating to a pressure p. For this purpose, the switchover devices 102, that is, the RAM and the FAM, are connected for communication purposes to the control device 120 and are configured to sense a pressure p affecting the valve assembly 100 and to transmit it to the control device 120. The outlet valve assembly 110 is configured, via the switching signal 125, to be switched to the first venting mode M1 above a pressure threshold 127 defining the threshold value condition 126 and/or to the second venting mode M2 below the pressure threshold 127.

The service brake system 250a includes two noise-reducing valves 111, which are illustrated in the schematic drawing in FIG. 3 together with the switchover devices 102 or the RAM and the FAM.

In this case, the service brake system 250a includes an outlet valve assembly 110 which has a plurality of ABS valves 255 as quick-venting valves 112. Here, each of the ABS valves 255 is connected to an actuator 210, which is configured as a service brake, for actuation of the respective actuator 210. Each of the actuators 210 is configured to brake a wheel or a pair of wheels (not indicated) of the vehicle 200a, 200b. The ABS valves 255 are configured to be operated as a fallback level in the second venting mode M2.

The vehicle 200a, 200b includes two muffling devices 265, and the ABS valves 255 are configured to vent via the switching device 102 and the muffling device 265 in the first venting mode M1.

The parking brake system 250b has a switchable outlet valve 101. The parking brake system 250b is connected fluidically to one of the muffling devices 265 in order to vent air via the muffling device 265 in the first venting mode M1.

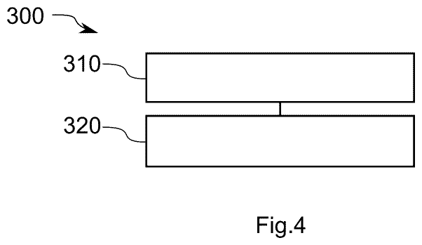

FIG. 4 shows a schematic illustration of a flow diagram of a method 300 according to an embodiment of the disclosure. The method 300 is a method 300 for operating a valve assembly 100 for a pneumatic system 250 of a vehicle 200a, 200b. A valve assembly 100 of this kind, a pneumatic system 250 of this kind and a vehicle 200a, 200b of this kind are described with reference to FIGS. 1 to 3. FIG. 4 is described with reference to FIGS. 1 to 3.

The method 300 includes: outputting 310 a switching signal 125 to an outlet valve assembly 110 of the valve assembly 100.

Switching 320 the outlet valve assembly 110 to the outlet valve assembly 110 to a noise-reducing first venting mode M1 or a quick-venting second venting mode M2 is accomplished via the switching signal 125.

It is understood that the foregoing description is that of the preferred embodiments of the invention and that various changes and modifications may be made thereto without departing from the spirit and scope of the invention as defined in the appended claims.

### REFERENCE SIGNS

50 working volume
52 inlet valve
54 outlet valve
58 compressed air reservoir
100 valve assembly
101 switchable outlet valve
102 switchover device
105 air
110 outlet valve assembly
111 noise-reducing valve
112 quick-venting valve
120 control device
121 vehicle state
122 vehicle speed
123 driving situation
125 switching signal
126 threshold value condition
127 pressure threshold
130 housing
135 braking value transmitter
200a vehicle
200b commercial vehicle
210 pneumatic actuator
250 pneumatic system
250a service brake system
250b parking brake system
250c air suspension system
250d transmission
255 ABS valve
260 vehicle component
265 muffling device
270 vehicle bus
275 connecting device
300 method
310 outputting
320 switching
P pressure
M1 noise-reducing first venting mode
M2 quick-venting second venting mode
MH hybrid venting mode

1. A valve assembly for a pneumatic system of a vehicle, the valve assembly comprising:
an outlet valve assembly for venting the pneumatic system;
a control device for operating the valve assembly in order to admit and release air to and from a pneumatic actuator;
said control device being configured to output, to said outlet valve assembly, a switching signal for switching said outlet valve assembly; and,
said outlet valve assembly being configured to be switched to a noise-reducing first venting mode or a quick-venting second venting mode via said switching signal.

2. The valve assembly of claim 1, wherein said control device is configured to output said switching signal taking into account at least one of a vehicle state, a vehicle speed, and a driving situation.

3. The valve assembly of claim 1, wherein at least one of said noise-reducing first venting mode is optimized for noise and said second venting mode is optimized for venting.

4. The valve assembly of claim 1, wherein said outlet valve assembly is configured to be switched via said switching signal to a hybrid venting mode; and, wherein, in said hybrid venting mode, said outlet valve assembly is configured to be switched to said first venting mode and to said second venting mode.

5. The valve assembly of claim 1, wherein said outlet valve assembly is configured to be switched via said switching signal in accordance with a threshold value condition relating to a pressure.

6. The valve assembly of claim 5, wherein said outlet valve assembly is configured to be switched, via said switching signal, to at least one of: said first venting mode above a pressure threshold defining the threshold value condition and said second venting mode below said pressure threshold.

7. The valve assembly of claim 1, wherein said outlet valve assembly is configured to enable air emerging from said outlet valve assembly to be fed to a vehicle component different from the valve assembly.

8. The valve assembly of claim 1, wherein said outlet valve assembly includes a noise-reducing valve and a quick-venting valve.

9. The valve assembly of claim 8 further comprising a housing; and, said noise-reducing valve and said quick-venting valve being arranged in said housing.

10. The valve assembly of claim 1, wherein said outlet valve assembly includes a switchover device and a switchable outlet valve; and, said switchover device is configured to switch said switchable outlet valve to said first venting mode or said second venting mode via said switching signal.

11. The valve assembly of claim 1, wherein the valve assembly is configured to switch said outlet valve assembly to said quick-venting second venting mode in a de-energized state.

12. The valve assembly of claim 1, wherein the vehicle is a commercial vehicle.

13. A pneumatic system for a vehicle, the pneumatic system comprising:
a valve assembly having an outlet valve assembly for venting the pneumatic system and a control device for operating the valve assembly in order to admit and release air to and from a pneumatic actuator;
said control device being configured to output, to said outlet valve assembly, a switching signal for switching said outlet valve assembly; and,
said outlet valve assembly being configured to be switched to a noise-reducing first venting mode or a quick-venting second venting mode via said switching signal.

14. The pneumatic system of claim 13 further comprising at least one of an electropneumatic service brake system, an electropneumatic parking brake system, an electropneumatic air suspension system, and an electropneumatic transmission.

15. The pneumatic system of claim 13 further comprising an electropneumatic service brake system; and, said outlet valve assembly including at least one ABS valve.

16. The pneumatic system of claim 15 further comprising a muffling device; and, said at least one ABS valve being configured to vent via said muffling device in said first venting mode.

17. The pneumatic system of claim 13, wherein the vehicle is a commercial vehicle.

18. A vehicle comprising the pneumatic system of claim 13.

19. A method for operating a valve assembly for a pneumatic system of a vehicle, the method comprising:
outputting a switching signal to an outlet valve assembly of the valve assembly; and,
switching the outlet valve assembly to a noise-reducing first venting mode or a quick-venting second venting mode via the switching signal.

20. A computer program and/or a computer-readable medium, comprising commands which, when the program or the commands is/are executed by a computer, cause the computer to carry out the method of claim 19.
